(19) United States
(12) Patent Application Publication
(10) Pub. No.: US 2025/0320377 A1
(43) Pub. Date: Oct. 16, 2025

(54) COATING FOR MAINTENANCE OF UNDERGROUND PIPES

(71) Applicant: MAGIECHEM INC., Candiac (CA)

(72) Inventor: Abdel Majid TELHOUNI, Longueuil (CA)

(21) Appl. No.: 19/178,023

(22) Filed: Apr. 14, 2025

Related U.S. Application Data
(60) Provisional application No. 63/634,498, filed on Apr. 16, 2024.

(51) Int. Cl. C09D 163/00; B05D 1/02; B05D 3/00; B05D 3/10; B05D 7/22; C09D 7/61; C09D 7/63

(52) U.S. Cl. CPC C09D 163/00; B05D 1/02; B05D 3/002; B05D 3/108; B05D 7/225; C09D 7/61; C09D 7/63; B05D 2254/04; B05D 2320/00; B05D 2504/00; B05D 2601/00

(57) ABSTRACT

There is provided a coating composition for rehabilitating an underground pipe, the coating comprising an epoxy resin, an epoxy hardener and from 5 to 40 wt. % of fiberglass. There is also provided a method of rehabilitating an underground pipe, the method comprising: making an opening in the underground pipe; inserting a coating device in the opening of the underground pipe; and moving the coating device inside the underground pipe while spraying a coating comprising an epoxy resin, an epoxy hardener and from 5 to 40 wt. % of fiberglass.

### CROSS-REFERENCE TO RELATED APPLICATION

The present application claims priority from U.S. provisional patent application No. 63/634,498 filed on Apr. 16, 2024. The content of the above-referenced application is incorporated herein by reference in their entirety.

### TECHNICAL FIELD

This disclosure relates to the field of maintenance and rehabilitation of underground pipes, including coatings for maintaining or rehabilitating the underground pipes and methods of applying the coatings inside the pipes.

### BACKGROUND OF THE ART

There are many traditional methods of rehabilitating underground pipes. In a first method, the old underground pipe is replaced with a new pipe that comes into contact with the old pipe. In a second method, a cathodic process is used to create a corrosion resistant coating on the inside walls of the underground pipe. In a third method, the old pipe is burst by providing a mechanical force from the inside of the pipe by an expanding replacement pipe. The remainders or shattered pieces of the old pipe are pushed into the adjacent soil leaving the space for the replacement pipe.

One major problem of the above three rehabilitation methods is that they require multiple points of digging across the length of the underground pipe in order to replace or coat the pipe. This makes the procedure much more costly and time consuming. The time it would take to perform a rehabilitation is also very important for cities that have underground pipes positioned below streets because this means that street closures are longer.

Impregnation with epoxy resin has emerged as a potential solution for rehabilitating underground pipes while requiring much less digging. Impregnation with epoxy resin can be performed inside the underground pipes for long distances. Accordingly, to cover the same distance with coating, the number of access points that need to be reach or dug out are significantly reduced. Therefore, this leads to an improvement in the time it takes to perform the rehabilitation and a cost reduction. However, there are still problems with impregnation of epoxy resin. It is slow curing and requires around 7 days to fully cure before the pipe can be used again. In addition, it is energy consuming because it utilizes heated water which is pushed inside the pipe to initiate the process of epoxy curing. This means that in the context of underground pipes laid beneath streets, these streets would be closed for around 7 days. Accordingly, improvements are still desired, and it would be more advantageous to have a coating that can cure faster than traditional epoxy resins.

Polyurea coatings have emerged as a potential solution for rehabilitating underground pipes while requiring much less time to deploy and cure. A polyurea coating can be spray coated inside the underground pipes for long distances. Polyurea coatings lead to an improvement in the application thickness and adhesion to the pipe, as well as the time it takes to perform the rehabilitation. However, there are still problems with polyurea coatings. Polyurea coatings cure faster than epoxy but require multiple applications to get the desired thickness of ⅛ of an inch to ¼ of an inch (about 3.175 to 6.350 mm) of coating before the pipe can be used again. Specifically, it takes around 4 layers of polyurea to obtain the desired thickness of about 3.175 to 6.350 mm. The requirement for multiple layers is a disadvantage in terms of both the cost and the time to perform the pipe rehabilitation. The polyurea curing is a reaction between an amine and an isocyanate prepolymer which is more sensitive to moisture. This creates more foams and a weak adhesion to the surface of the pipe. Thus, the end product becomes more brittle and has more imperfections at the surface. Accordingly, improvements are still desired, and it would be more advantageous to have a coating that can cure faster than epoxy and has reduced sensitivity to moisture compared to polyurea.

### SUMMARY

In one aspect, there is provided a coating for rehabilitating an underground pipe, the coating comprising an epoxy resin and from 5 to 40 wt. % of fiberglass. The coating preferably has a thickness of up to 13 mm. The epoxy resin can be selected from bisphenol A, bisphenol F, a phenolic resin, or a combination thereof. The epoxy hardener is selected from amine, amido-amine, polyamides, aliphatic, aromatic, cycloaliphatic amines and combinations thereof.

In a further aspect, there is provided a use of the coating composition, for rehabilitating an underground pipe.

In a further aspect, there is provided a method of rehabilitating an underground pipe, the method comprising: making an opening in the underground pipe; inserting a coating device at a first opening of the underground pipe; and moving the coating device from the first opening to the second opening while spraying a coating comprising an epoxy resin, an epoxy hardener and from 5 to 40 wt. % of fiberglass. The method can further comprise before inserting the coating device, performing a wash on the inside walls of the underground pipe by spraying pressurized water, and spray drying the underground pipe with pressurized air after the washing. The method can also further comprises curing the coating for a duration of up to 24 h. In one example, the coating is applied in a thickness of 1 to 13 mm. In some embodiments, the distance between the first opening and the second opening is at least 100 m. In some embodiments, the epoxy resin and the epoxy hardener are provided in a weight ratio (resin:hardener) of from 1:10 to 10:1, preferably the ratio is from 1:4 to 4:1.

Many further features and combinations thereof concerning the present improvements will appear to those skilled in the art following a reading of the instant disclosure.

### DESCRIPTION OF THE DRAWINGS

FIG. 1 is a schematic representation of the application of a coating according to one embodiment of the present disclosure.

### DETAILED DESCRIPTION

There is provided an epoxy-based coating composition containing an addition of fiberglass for coating and rehabilitating underground pipes. The present coating composition and resulting coating exhibit advantages compared to traditional epoxy resins. The advantages include not being sensitive to moisture, having a faster curing time, an improved durability and robustness as well as improved coating thickness per layer. In other words, the coating of the present disclosure only needs to be provided in a single layer to have a thickness that is sufficient to rehabilitate the underground pipe. Indeed, a first application of the present coating composition can provide a coating that is four times thicker than traditional coatings. Accordingly, compared to traditional epoxy impregnations rehabilitations of underground pipes in city streets which would take 10 days, this duration can be reduced to a single day or two days with the present coating composition. It should be noted, however, that the duration of the curing will vary based on the coating thickness applied. This reduction in time significantly reduces costs of rehabilitating underground pipes, particularly when it comes to underground pipes in cities that require street closure. The cost of rehabilitating the pipe is not only the cost of performing the rehabilitation but also the indirect cost associated with street closures. Moreover, the traditional epoxy impregnation requires the application of hot water (e.g. 80-90° C.) or vapor to facilitate polymerization. This is not required for the application of the present epoxy-based coatings. Thus, in some embodiments, the present methods of coating the epoxy-based coating inside an underground pipe are free of hot water or vapor applications. This is yet another advantage of the present coatings when compared to the traditional epoxy resin impregnation since hot water and vapor are an additional cost that is avoided by the present coating composition.

The epoxy-based coating composition of the present disclosure comprises an epoxy resin, an epoxy hardener and fiberglass. In some embodiments, a weight ratio of the resin (X) to the hardener (Y) is from 1:10 to 10:1. In some embodiments, X:Y is from 1:9 to 1:9, from 1:8 to 8:1, from 1:7 to 7:1, from 1:6 to 6:1, from 1:5 to 5:1, from 1:4 to 4:1, from 1:3 to 3:1, from 1:2 to 2:1, about 1:1, about 2:1, about 3:1, or about 4:1.

Examples of epoxy resins include but are not limited to bisphenol A, bisphenol F, a phenolic resin, or a combination thereof. Examples of epoxy hardeners include amine, amido-amine, polyamides, or a mixture of aliphatic, aromatic and cycloaliphatic amines. An example of bisphenol A is D.E.R.™ 331, and an example of bisphenol F is D.E.R.™ 354. Other examples of epoxy coatings include phenol formaldehyde resins such as D.E.N.™ 431-438 Epoxy Novolac™ resin. The hardener is for example a combination of aliphatic amine (amino ethyl piperazine and tetraethyl amine), a cycloaliphatic amine (m-xylylenediamine, hexamethylenediamine and isophorone diamine).

Fiberglass is provided in the coating composition in a concentration of from 5 to 40 wt. % with regards to the total weight of the composition. In some embodiments, the fiberglass is provided in a concentration of from 10 to 40 wt. %, from 15 to 40 wt. %, from 20 to 40 wt. %, or from 10 to 30 wt. %. The addition of fiberglass provides desirable mechanical properties and a structural integrity to the coating. In combination with the fast-curing epoxy resin, the resulting coating has improved properties as explained above as well as improved curing time.

Fiberglass is a fiber-reinforced plastic using glass fiber. The fiberglass increases the young modulus and flexural straight of the coating. The fiberglass used in the present coating composition have a length of from 0.5 mm to 6 mm. In some embodiments, the fiberglass is characterized by having a median length of from 0.5 mm to 6 mm. In other embodiments, the fiberglass is characterized by having an average length of up to 13 mm, for example from 1 mm to 13 mm. In still other embodiments, at least 90% of the fiberglass provided in the present coating have a length of from 0.5 mm to 6 mm.

The present method of applying the coating composition is a trenchless technique. Trenchless techniques are used for laying, replacing, rehabilitating, renovating, repairing or inspecting urban technical network pipes, or locating and detecting leaks in this type of structure, with no or minimum digging from the ground surface. The trenchless method can be operated by remote control on the ground. In some cases, an access to the underground pipe may already exist and be available. Accordingly, it is not necessary to perform a digging operation to reach the underground pipe. If an access point is needed to reach the pipe, a microtunneler can be used to perform the digging. The microtunneler can be steered from a control panel generally located on the surface. A minimum of one access point is needed however generally two access points are made, one to place the coating device in and one to retrieve it. Depending on the state of the pipe, a wash with pressurized water (e.g. 2000-3000 psi) may be needed to clear the pipe before applying the coating. The washing is followed by a drying step with pressurized air. The pipe can then be scanned or inspected to determine whether it is ready to receive a coating. When a single access point is available, such as a manhole, the coating device is sent into the underground pipe from the access point and moves inside the pipe until a desired coating distance is reach. Then, the coating device is pulled back to the access point while applying the coating. On the other hand, when two access points are available, the coating device can be placed on one side of the access points and then moved to the access point while applying the coating on the internal walls of the pipe. The distance between the two points can vary based on the availability of access points and the availability to dig an access point. The coating device can have a motor in order to independently move within the pipe. It is also possible to not have a motorized coating device and simply attach the device to a rope in order to pull the coating device. For example, in a densely populated city, it is not possible to have an access point under a residential or commercial building and only street access is available. This means that the distance between the two access points needs to be adapted based on the landscape on the ground above the underground pipe. In some cases, the distance covered by the coating device when applying the coating composition is at least 100 m, at 150 m least, at least 200 m, at least 250 m, at least 300 m, at least 400 m, or at least 500 m. The distance can be up to 2 km, up to 1.5 km or up to 1 km.

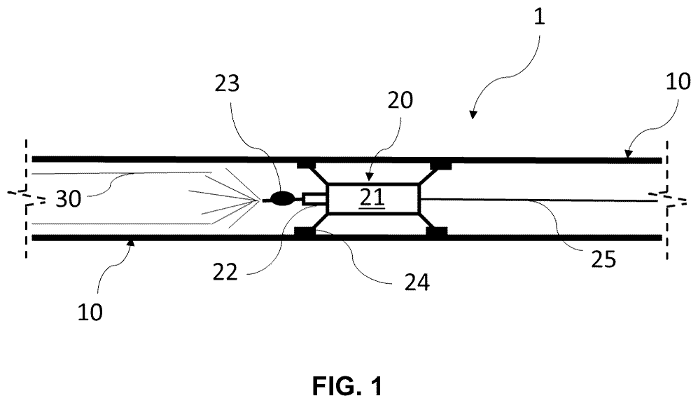

Making reference to FIG. 1, there is provided a schematic 1 showing a cross section of a section of an underground pipe 10 being coated. The coating device 20 moves along the pipe 10 to provide a coating 30 inside the pipe 10. The coating device has a body 21, a mixer 22 for mixing the components of the coating and a nozzle 23 for spraying the coating. The coating device 20 also has wheels 24 or other means of sliding along the length of the pipe. The coating device 20 moves inside the pipe with a motor or is pulled by a rope 25 which is controlled by a system above ground. In preferred embodiments, a rotating nozzle is used to allow adjustment of the spray angle from 15 to 110 degrees. In preferred embodiments, the mixer is a static mixer which has a diameter of from ⅛ of an inch to 1 inch. The static mixer is in fluid communication with two reservoirs in the coating device, one containing the epoxy and the other containing the hardener. The fiberglass could be contained in a third reservoir in mixed with the epoxy and/or the hardener.

The coating of the present disclosure resulting from the application of the coating composition meets the certification American Society for Testing and Materials (ASTM) F1216. In preferred embodiments, the coating also meets the potable water certification National Sanitation Foundation (NSF)/American National Standards Institute (ANSI) 61. The present coating composition can be applied in thicknesses of from 3 to 13 mm, from 4 to 13 mm, from 5 to 13 mm or from 6 to 13 mm. The thickness of the present coating exceeds the thickness achieved by a single layer of polyurea coatings which is generally around 1 mm. Preferably, the coating can resist water pressures inside the underground pipe when in use of around 200-250 psi.

Optionally, if desired, a second coating of polyurea is applied on the coating of the present disclosure. In this embodiment, the coating that rehabilitates and treat the underground is the coating of the present disclosure and the second polyurea coating is only provided as a secondary layer to act as an interface with the water or other liquid that flows inside the underground pipe.

### EXAMPLE

The spray coating was performed with an apparatus having two cartridge tubes of 600 mL which mixes the contents of the tube when performing the spray coating through its nozzle. A first master mix was obtained by mixing 70.0 kg of Araldite™ GY 6010 (a liquid epoxy resin), 0.3 kg of BYK™-9076/BYK™-9077 (a solvent-free wetting and dispersing additive), 0.3 kg of BYK™-054 (a silicone-free defoamer), 1.4 kg of bentone SD2 (a rheological additive), 20.0 kg of fiberglass, 7.0 kg of Minex™ 10 (a filler), and 1 kg of BYK™-R607 (a rheology additive). A second master mix was obtained by mixing 42.0 kg of Ancamine™ 2432 (a curing agent), 10.0 kg of m-Xylylenediamine (MXDA), 4.0 kg of Ancamine™ AEP (a curing agent made of 96% minimum purity grade of N-aminoethyl-piperazine), 40 kg of fiberglass, and 4.0 kg of a mixture of HJSIL™ 200 (a hydrophilic fumed silica with a specific surface area of 200 m²/g) and CABOSIL™ (a thickening agent). The first 600 ml tube was filled with 1000 g of the first master mix and the second 600 ml tube was filled with 1000 g of the second master mix.

Samples were then spray coated onto a substrate according to ASTM D790 and a deposition of sample was performed to obtain a rectangular shape having the dimensions of 1 inch×3 inches×⅛ inch. The mechanical properties were measured using an Electromechanical Universal Testing Machine 50KN from NextGen™. The stress and young modulus measurements were made at days 1, 2, 5, 6 and 7 for 5 replicates of the sample labeled samples 1-5. The results are presented in Table 1.

TABLE 1
Stress and young modulus measured over 7 days

| | Days | Sample 1 | Sample 2 | Sample 3 | Sample 4 | Sample 5 | Average |
|---|---|---|---|---|---|---|---|
| Stress | 1 | 36.00 | 32.72 | 38.81 | 44.09 | 36.03 | 37.53 |
| | 2 | 36.46 | 37.30 | Nm | 42.97 | 41.01 | 39.44 |
| | 5 | 43.99 | 48.98 | 37.07 | 40.03 | Nm | 42.52 |
| | 6 | 43.81 | 32.18 | 51.77 | 42.90 | 45.72 | 43.27 |
| | 7 | 45.58 | 45.59 | 41.81 | 47.60 | 41.91 | 44.50 |
| Young | 1 | 2127.48 | 1676.18 | 1787.17 | 2358.63 | 1833.17 | 1956.53 |
| Modulus | 2 | 2359.29 | 1706.72 | Nm | 2256.09 | 1918.21 | 2060.08 |
| | 5 | 2120.45 | 2189.95 | 2108.39 | 1713.62 | Nm | 2033.10 |
| | 6 | 2418.81 | 1728.36 | 2581.08 | 2230.81 | 2507.29 | 2293.27 |
| | 7 | 2302.45 | 2466.85 | 2078.64 | 2399.24 | 2281.14 | 2305.66 |

Nm = not measured

As can be seen from Table 1, over the course of 7 days the stress and young modulus were maintained within the same range of values showing that a curing of 24 h was sufficient thereby demonstrating a curing which only required one day.

What is claimed is:

1. A coating composition for rehabilitating an underground pipe, the coating comprising an epoxy resin, an epoxy hardener and from 5 to 40 wt. % of fiberglass.

2. The coating composition of claim 1, wherein the coating has a thickness of up to 13 mm.

3. The coating composition of claim 1, wherein the epoxy resin is selected from bisphenol A, bisphenol F, a phenolic resin, or a combination thereof.

4. The coating composition of claim 1, wherein the epoxy hardener is selected from amine, amido-amine, polyamides, aliphatic, aromatic, cycloaliphatic amines and combinations thereof.

5. The coating composition of claim 1, wherein the epoxy resin and the epoxy hardener are provided in a weight ratio (resin:hardener) of from 1:10 to 10:1.

6. The coating composition of claim 5, wherein the ratio is from 1:4 to 4:1.

7. A method of rehabilitating an underground pipe, the method comprising:
inserting a coating-applying device at an opening of the underground pipe; and
moving the coating-applying device inside the underground pipe while spraying a coating comprising an epoxy resin, an epoxy hardener and from 5 to 40 wt. % of fiberglass.

8. The method of claim 7, further comprising before inserting the coating device, performing a wash on the inside walls of the underground pipe by spraying pressurized water.

9. The method of claim 8, further comprising spray drying the underground pipe with pressurized air after the washing.

10. The method of claim 7, further comprising curing the coating for a duration of up to 24 h.

11. The method of claim 7, wherein the coating is applied in a thickness of up to 13 mm.

12. The method of claim 7, wherein the distance of coating composition sprayed is at least 100 m.

13. The method of claim 7, wherein the epoxy resin and the epoxy hardener are provided in a weight ratio (resin:hardener) of from 1:10 to 10:1.

14. The method of claim 13, wherein the ratio is from 1:4 to 4:1.
